(19) United States
(12) Patent Application Publication
(10) Pub. No.: US 2010/0108782 A1
(43) Pub. Date: May 6, 2010

(54) FOAM NOZZLE FOR ASSEMBLY ONTO A TRIGGER-TYPE SPRAYER

(75) Inventor: Kun-Lung Tseng, Taichung Hsien (TW)

Correspondence Address: EGBERT LAW OFFICES, 412 MAIN STREET, 7TH FLOOR, HOUSTON, TX, 77002, US

(73) Assignee: LIVING FOUNTAIN PLASTIC INDUSTRIAL CO., Ltd., Dali City (TW)

(21) Appl. No.: 12/262,086

(22) Filed: Oct. 30, 2008

(51) Int. Cl. B05B 1/26; B05B 7/30

(52) U.S. Cl. 239/343; 239/504; 239/507

(57) ABSTRACT

The present invention provides a foam nozzle for assembly onto a trigger-type sprayer. The foam nozzle includes a base plate, containing front and rear faces, a plurality of pins, arranged at intervals, a straight tube, protruding vertically from the front face of the base plate, an orifice defined within the straight tube, and a mesh body, arranged on the nozzle orifice of the straight tube. The mesh body includes a circular rib and a plurality of radial ribs. A convex rib protruding from the interior of the circular rib is contained within the radial ribs. A central orifice is formed between the convex ribs, while a plurality of annular orifices is formed between the circular rib and the radial ribs. The foam nozzle can be assembled into a plurality of grooves for the nozzle of existing trigger-type sprayer to generate foaming spray.

### CROSS-REFERENCE TO RELATED U.S. APPLICATIONS

Not applicable.

### STATEMENT REGARDING FEDERALLY SPONSORED RESEARCH OR DEVELOPMENT

Not applicable.

### NAMES OF PARTIES TO A JOINT RESEARCH AGREEMENT

Not applicable.

### REFERENCE TO AN APPENDIX SUBMITTED ON COMPACT DISC

Not applicable.

### BACKGROUND OF THE INVENTION

1. Field of the Invention

The present invention relates generally to a component of a trigger-type sprayer, and more particularly to an innovative foam nozzle which is exclusively assembled onto the trigger-type sprayer.

2. Description of Related Art Including Information Disclosed Under 37 CFR 1.97 and 37 CFR 1.98

Currently, there are a variety of liquid cleansers on the market, for which the containers are generally designed with a trigger-type sprayer for easy spraying of liquid.

The trigger-type sprayer is mainly composed of a nozzle, a trigger, a suction valve and a suction tube. The nozzle is designed with columnar fog-like spray switching modes, in addition to opening/closing switching modes.

However, the aforementioned columnar fog-like spraying modes could not meet the continuously growing customer demands. For example, when an operator intends to wash cars, only a foaming spray could provide better adhesion and distribution effect for subsequent wiping with sponge.

It is difficult to modify the nozzle of the existing trigger-type sprayer into a foam spraying nozzle due to complexity of the structure. If a foam spraying nozzle is directly installed, it is not helpful to the trigger-type sprayer currently commercially available. Such a common trigger-type sprayer could not generate foam spraying effect.

Thus, to overcome the aforementioned problems of the prior art, it would be an advancement in the art to provide an improved structure that can significantly improve efficacy.

Therefore, the inventor has provided the present invention of practicability after deliberate design and evaluation based on years of experience in the production, development and design of related products.

### BRIEF SUMMARY OF THE INVENTION

The foam nozzle of the present invention can be assembled quickly onto the nozzle of an existing trigger-type sprayer to generate a foaming spray, thus improving the performance of existing trigger-type sprayer. Given a great number of commercially available nozzles of the same type, if the foam nozzle of the present invention is assembled onto an existing trigger-type sprayer, it is possible to realize excellent ease-of-operation without the need of disassembly or impairment of previous functions.

Based on the straight guiding structure of the orifice of the straight tube and the interval outlet of the mesh body 50, the sprayed liquid is mixed with air during the foaming process, and then sprayed from a straight channel to generate the refined foaming effect for meeting optimum operating requirements.

Based on the structure of a pressure rib formed at inner side of the pin, more secure fixation is enabled when the pin is plugged into the groove of the nozzle of the trigger-type sprayer.

Although the invention has been explained in relation to its preferred embodiment, it is to be understood that many other possible modifications and variations can be made without departing from the spirit and scope of the invention as hereinafter claimed.

### BRIEF DESCRIPTION OF THE SEVERAL VIEWS OF THE DRAWINGS

FIG. 1 shows a perspective view of a preferred embodiment of the foam nozzle of the present invention.

FIG. 2 shows a front elevation view of a preferred embodiment of the foam nozzle of the present invention.

FIG. 3 shows a rear elevation view of a preferred embodiment of the foam nozzle of the present invention.

FIG. 4 shows a sectional view a preferred embodiment of the foam nozzle of the present invention.

FIG. 5 shows an exploded perspective view of the assembly relationship of the foam nozzle and trigger-type sprayer of the present invention.

FIG. 6 shows an assembled perspective view of the foam nozzle and trigger-type sprayer of the present invention.

FIG. 7 shows an assembled elevation view of the foam nozzle and trigger-type sprayer of the present invention.

FIG. 8 shows a perspective view of the operation of the foam nozzle of the present invention.

FIG. 9 shows a perspective view of another application of the mesh-type foam nozzle.

### DETAILED DESCRIPTION OF THE INVENTION

The features and the advantages of the present invention will be more readily understood upon a thoughtful deliberation of the following detailed description of a preferred embodiment of the present invention with reference to the accompanying drawings.

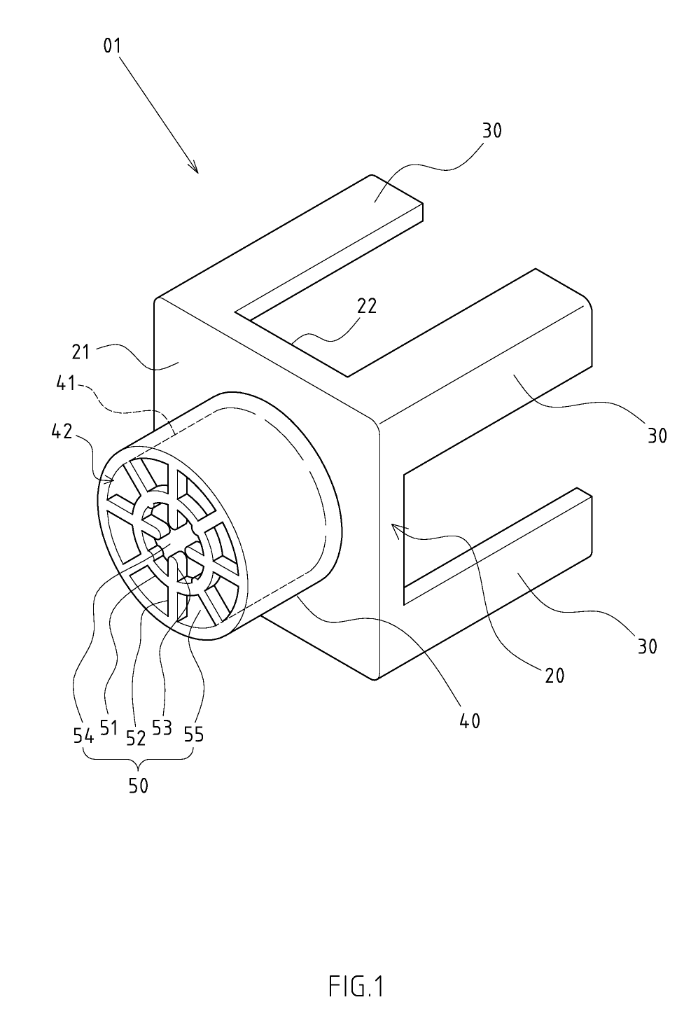

FIGS. 1-4 depict preferred embodiments of foam nozzle of the present invention. The embodiments are only provided for explanatory objectives with respect to the patent claims.

Referring to FIG. 5, the foam nozzle 01 is exclusively assembled into a plurality of grooves 12 on the nozzle 11 of existing trigger-type sprayer 10 so as to generate foaming spray. The foam nozzle 01 comprises a base plate 20, containing a front face 21 and a rear face 22.

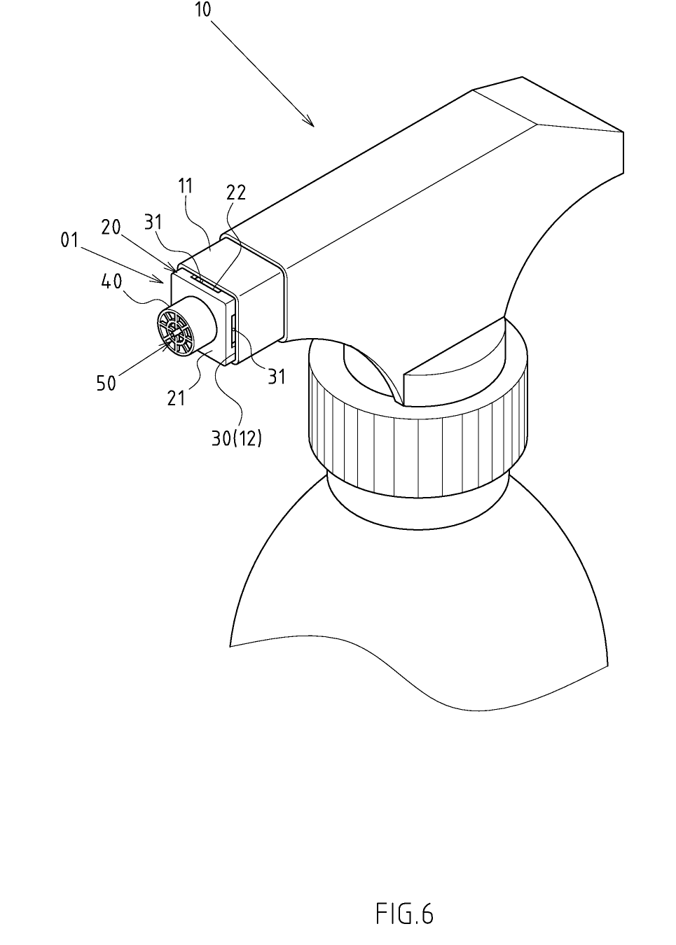

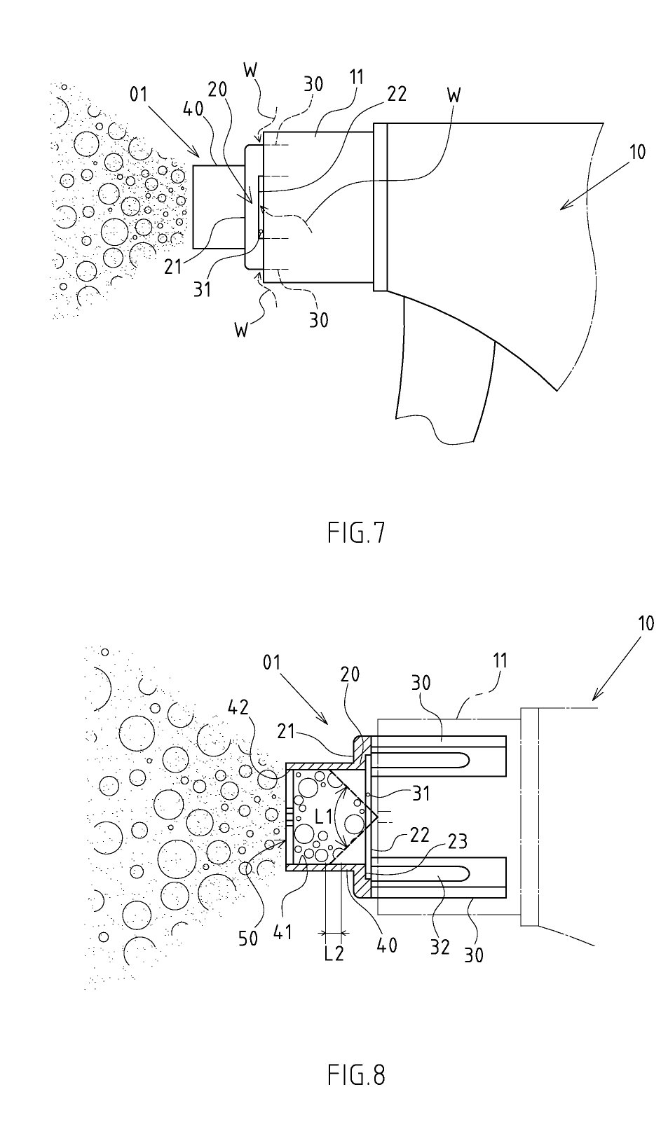

A plurality of pins 30 allow for vertical protrusion of the rear face 22 of the base plate 20. The pins 30 are arranged at intervals and located properly for plugging into a plurality of grooves 12 of the nozzle 11 of the trigger-type sprayer 10. Referring to FIGS. 6 and 7, the pins 30 are not fully plugged into the grooves 12. Then, an air inlet space 31 is shaped at intervals between the rear face 22 of the base plate 20 and the nozzle 11 of the trigger-type sprayer 10, making it possible to mix the laterally guided air (W) and liquid sprayed from the nozzle 11 of the trigger-type sprayer 10 and generate foaming spray.

A straight tube 40, which is a hollow tube of predefined length, protrudes vertically from the front face 21 of the base plate 20. An orifice 41 is defined within the straight tube 40. The interior of the orifice 41 penetrates the base plate 20, while an open-end nozzle orifice 42 is defined at the exterior of orifice 41.

A mesh body 50 is arranged on the nozzle orifice 42 of the straight tube 40. The mesh body 50 comprises at least a circular rib 51 and a plurality of radial ribs 52. A convex rib 53 protruding from the interior of the circular rib 51 is contained within the radial ribs 52. A central orifice 54 is formed between the convex ribs 53, while a plurality of annular orifices 55 is formed between the circular rib 51 and the radial ribs 52.

The nozzle 11 of the trigger-type sprayer 10 is generally of a square shape, and a plurality of grooves 12 in a triangular shape are arranged at four corners of the nozzle 11, so that the base plate 20 of the foam nozzle 01 is correspondingly a square shape. The pins 30 are placed separately at four corners of the base plate 20. The cross section of the pins 30 is of a triangular shape that matches the aforementioned triangular groove 12.

The base plate 20, pins 30, straight tube 40 and mesh body 50 of the foam nozzle 01 are made of plastics from injection molding.

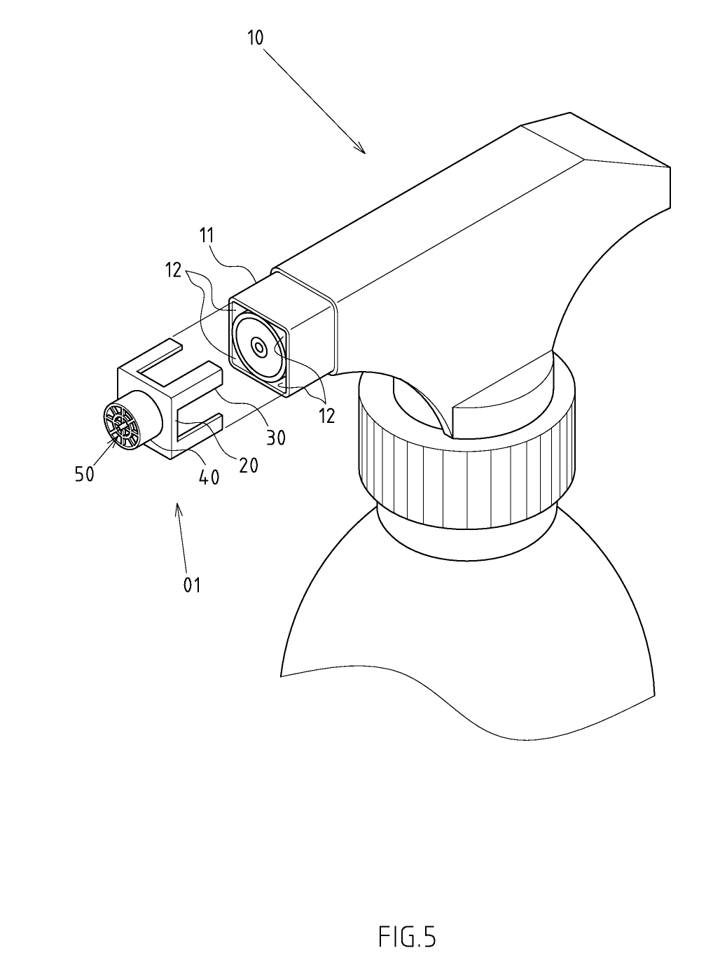

Referring to FIGS. 3 and 4, a pressure rib 32 is formed at inner side of the pin 30. The pressure rib 32 is arranged nearby the rear face 22 of the base plate 20. This could provide more secure fixation effect when the pin 30 is plugged into the groove 12 of the nozzle 11 of the trigger-type sprayer 10.

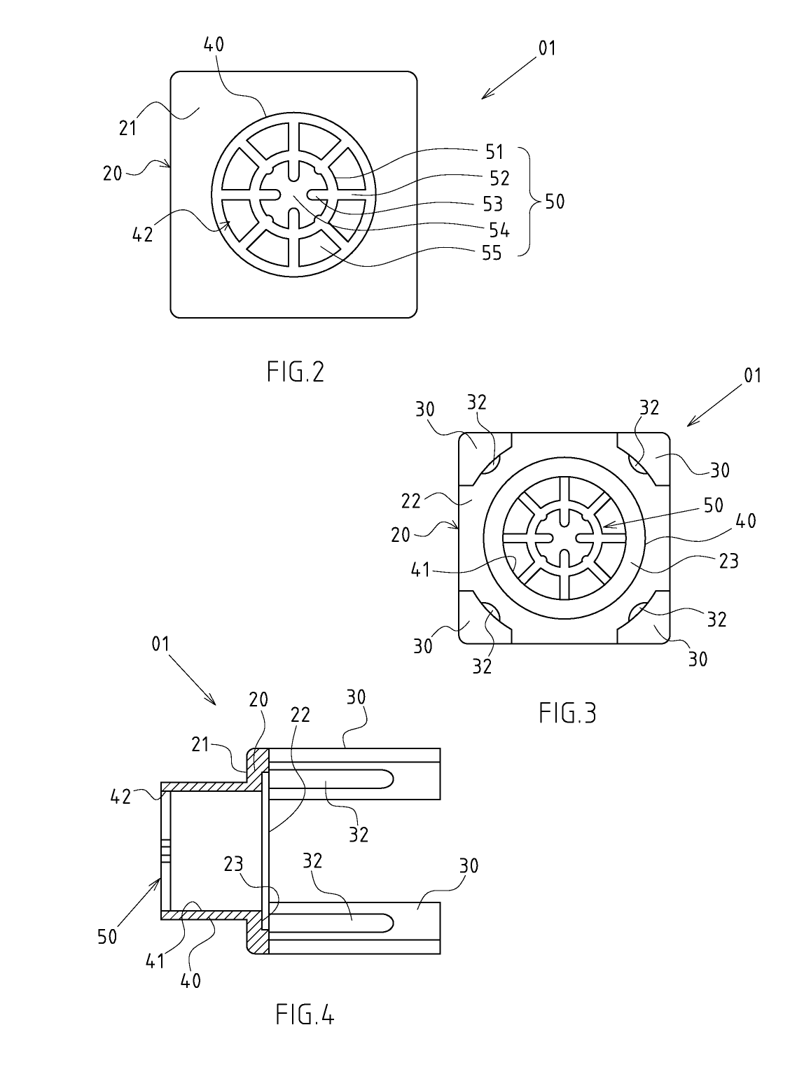

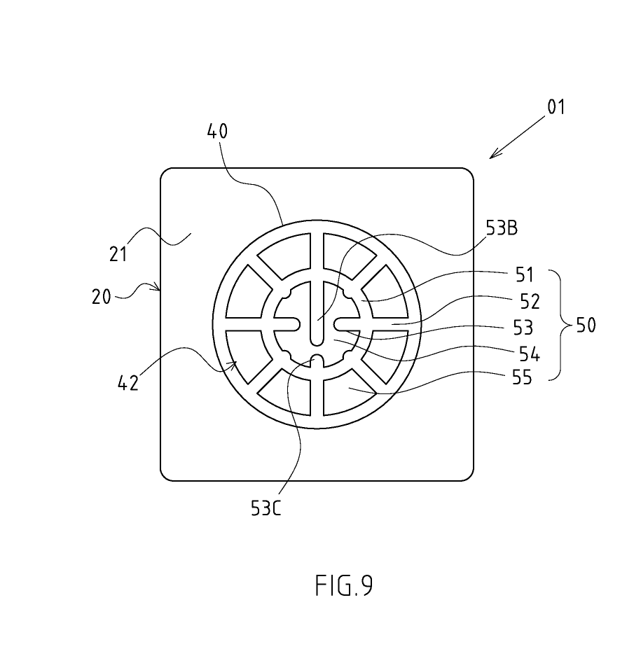

The convex ribs 53 of the mesh body 50 are arranged in isometric form (shown in FIG. 2) or the convex ribs 53, 53B, 53C of the mesh body 50 are arranged in a non-isometric form (shown in FIG. 9). The convex rib 53B is designed into a top-to-down pulling shape, and the convex rib 53C is designed into a shorter down-to-top protruding shape, thereby acquiring different types of water spray.

Referring to FIGS. 3 and 4, an annular concave 23 is shaped between the inner end of orifice 41 of the straight tube 40 and rear face 22 of the base plate 20. With the design of annular concave 23, a stepped fault is formed between the rear face 22 of the base plate 20 and the orifice 41 of the straight tube 40, making it possible to guide air smoothly from air inlet space 31.

Referring to FIG. 8, the foam nozzle 01 is assembled on the nozzle 11 of the trigger-type sprayer 10, such that the liquid spraying angle (L1) of the nozzle 11 is directed towards ⅓-½ at inner side of orifice 41 of the straight tube 40 (shown in L2 in FIG. 8). With this design, the liquid sprayed from the nozzle 11 is mixed with air from orifice 41 of the straight tube 40, and then sprayed from a straight channel to generate refined foaming effect.

Based on above-specified structures, the present invention is operated as follows:

Referring to FIGS. 7 and 8, the foam nozzle 01 is assembled on the nozzle 11 of the trigger-type sprayer 10, where liquid is sprayed to generate suction action. In such a case, air inlet space 31 formed between the rear face 22 of base plate 20 and nozzle 11 of the trigger-type sprayer 10 will guide laterally external air (W) to mix with the liquid sprayed from the nozzle 11 of the trigger-type sprayer 10, thus generating a foaming effect. Furthermore, with the straight guiding design of the orifice 41 of the straight tube 40 and the interval outlet design of the mesh body 50, the foaming spray could be realized with optimized effect.

1. A foam nozzle for assembly onto a trigger-type sprayer having a spray nozzle with a plurality of grooves, said grooves engaging said foam nozzle to generate a foaming spray said foam nozzle comprising:
a base plate, containing a front face and a rear face;
a plurality of pins, allowing for vertical protrusion of said rear face of said base plate, being arranged at intervals, and being located corresponding to said plurality of grooves of said spray nozzle, said pins being partially plugged into the grooves and forming an air inlet space shaped at intervals between said rear face of said base plate and said spray nozzle;
a straight tube, being hollow and protruding vertically from said front face of said base plate;
an orifice defined in said straight tube having an interior penetrating said base plate, an open-end nozzle orifice being defined at an exterior of said orifice; and
a mesh body, being arranged on a nozzle orifice of said straight tube and being comprised of a circular rib and a plurality of radial ribs, said circular rib having a convex rib protruding from an interior thereof and being contained within said radial ribs, said convex rib having a central orifice formed therebetween, said circular rib and said radial ribs forming a plurality of annular orifices.

2. The foam nozzle defined in claim 1, wherein said spray nozzle of the trigger-type sprayer is of a square shape, and said plurality of grooves are arranged at four corners of said spray nozzle, said base plate corresponding in shape to said square shape, said pins being placed separately at four corners of the base plate.

3. The foam nozzle defined in claim 1, wherein each of said pins has a cross section of a triangular shape.

4. The foam nozzle defined in claim 1, wherein the base plate, pins, straight tube and mesh body are comprised of plastics from injection molding.

5. The foam nozzle defined in claim 1, further comprising a pressure rib formed at an inner side of each pin.

6. The foam nozzle defined in claim 1, wherein the convex ribs of the mesh body are arranged in isometric or non-isometric form.

7. The foam nozzle defined in claim 1, further comprising an annular concave shaped between an inner end of said orifice of said straight tube and said rear face of said base plate.

8. The foam nozzle defined in claim 1, being assembled on said spray nozzle of the trigger-type sprayer at a liquid spraying angle directed towards ⅓-½ at an inner side of said orifice of said straight tube.
